(19) United States
(12) Patent Application Publication
(10) Pub. No.: US 2024/0377205 A1
(43) Pub. Date: Nov. 14, 2024

(54) METHOD AND APPARATUS FOR DETERMINING LANE’S CENTERLINE NETWORK

(71) Applicant: 42DOT INC., Seoul (KR)

(72) Inventors: Ho Sung KIM, Goyang (KR); Jong Bum CHOI, Seoul (KR); Ja Yong LEE, Seongnam (KR)

(21) Appl. No.: 18/563,938

(22) PCT Filed: May 26, 2022
(86) PCT No.: PCT/KR2022/007488

§ 371 Date: Nov. 24, 2023

(30) Foreign Application Priority Data
May 26, 2021 (KR) 10-2021-0067943
Nov. 9, 2021 (KR) 10-2021-0153157
Nov. 9, 2021 (KR) 10-2021-0153173
Nov. 9, 2021 (KR) 10-2021-0153193

(51) Int. Cl. G01C 21/32

(52) U.S. Cl. CPC G01C 21/32

(57) ABSTRACT

The disclosure relates to a method and an apparatus for determining a lane centerline network. A lane centerline network determination method according to an embodiment of the disclosure may include obtaining a driving trajectory of a vehicle by using a global positioning system (GPS) mounted on the vehicle, matching a road map with the driving trajectory, generating road feature information considering the driving trajectory based on an image captured by an image capturing device mounted on the vehicle, determining a position of a section node dividing a road on the road map into a plurality of sections based on the road feature information, determining a lane centerline placement for each section by determining a lane centerline for the traveling lane of the vehicle among a plurality of lanes included in the section based on the driving trajectory, and estimating lane centerlines for remaining lanes, determining a final longitudinal position of the section node based on reliability of the section node for each of driving trajectories through which the vehicle has passed a same road repeatedly, determining a section network connection relationship between the section, a previous section, and a next section based on the lane centerline placement for each section, determining a geometry of the lane centerline placement for each section based on reliability of a section link connecting the section nodes to each other, and generating a lane centerline network based on the section network connection relationship and a lane centerline geometry within the section.

### TECHNICAL FIELD

The disclosure relates to a lane centerline network determination method and a lane centerline network determination apparatus.

### BACKGROUND ART

A vehicle may travel in one lane among a plurality of lanes included in a road. A vehicle may frequently change lanes while traveling, and situations in which the number of lanes on a road changes also frequently occur.

Smartization of vehicles is rapidly progressing due to the convergence of information and communication technology and vehicle industry. Due to smartization, vehicles have evolved from simple mechanical devices to smart cars, and in particular, autonomous driving has attracted attention as a core technology for smart cars. Autonomous driving is a technology that allows a vehicle to reach its destination on its own without a driver having to operate a steering wheel, an accelerator pedal, a brake, or the like. Various additional functions related to autonomous driving are continuously being developed, and research is required to provide a safe autonomous driving experience to passengers by controlling vehicles while recognizing and determining driving environments by using various data.

Recently, in this regard, research is needed to accurately generate a lane centerline network of a road map on which vehicles travel.

The background art is technical information possessed by the inventors for the derivation of the disclosure or obtained during the derivation of the disclosure, and is not necessarily known technology disclosed to the general public prior to the filing of the disclosure.

### DISCLOSURE

### Technical Problem

The disclosure provides a lane centerline network determination method and a lane centerline network determination apparatus. Objectives of the disclosure are not limited to those described above, and other objectives and advantages of the disclosure not described herein will be understood from the following description and will be more clearly understood from embodiments. In addition, it will be apparent that the objectives and advantages to be achieved by the disclosure may be realized by means presented in the claims and combinations thereof.

### Technical Solution

A first aspect of the disclosure may provide a lane centerline network determination method including obtaining a driving trajectory of a vehicle by using a global positioning system (GPS) mounted on the vehicle, matching a road map with the driving trajectory, generating road feature information considering the driving trajectory based on an image captured by an image capturing device mounted on the vehicle, determining a position of a section node dividing a road on the road map into a plurality of sections based on the road feature information, determining a lane centerline placement for each section by determining a lane centerline for the traveling lane of the vehicle among a plurality of lanes included in the section based on the driving trajectory, and estimating lane centerlines for remaining lanes, determining a final longitudinal position of the section node based on reliability of the section node for each of driving trajectories through which the vehicle has passed a same road repeatedly, determining a section network connection relationship between the section, a previous section, and a next section based on the lane centerline placement for each section, determining a geometry of the lane centerline placement for each section based on reliability of a section link connecting the section nodes to each other, and generating a lane centerline network based on the section network connection relationship and a lane centerline geometry within the section.

A second aspect of the disclosure may provide a lane centerline network determination apparatus including a memory in which at least one program is stored, and a processor configured to perform operations by executing the at least one program, wherein the processor is further configured to obtain a driving trajectory of a vehicle by using a global positioning system (GPS) mounted on the vehicle, match a road map with the driving trajectory, generate road feature information considering the driving trajectory based on an image captured by an image capturing device mounted on the vehicle, determine a position of a section node dividing a road on the road map into a plurality of sections based on the road feature information, determine a lane centerline placement for each section by determining a lane centerline for the traveling lane of the vehicle among a plurality of lanes included in the section based on the driving trajectory, and estimating lane centerlines for remaining lanes, determine a final longitudinal position of the section node based on reliability of the section node for each of driving trajectories through which the vehicle has passed a same road repeatedly, determine a section network connection relationship between the section, a previous section, and a next section based on the lane centerline placement for each section, determine a geometry of the lane centerline placement for each section based on reliability of a section link connecting the section nodes to each other, and generate a lane centerline network based on the section network connection relationship and a lane centerline geometry within the section.

A third aspect of the disclosure may provide a computer-readable medium having recorded thereon a program for causing a computer to execute the method according to the first aspect of the disclosure.

In addition, the disclosure may further provide another method of implementing the disclosure, another system for implementing the disclosure, and a computer-readable recording medium having recorded thereon a computer program for performing the method.

Other aspects, features, and advantages of the disclosure will become better understood through the accompanying drawings, the appended claims, and the detailed description.

### Advantageous Effects

A technical solution of the disclosure does not use images directly but uses only vehicle trajectory and road feature information, and thus, is lightweight and enables fast production, compared to light detection and ranging (LiDAR) or image-based lane centerline detection methods.

A map production cost is low, expensive equipment is not required, and a lot of manpower is not required. In addition, there are not many types of input information and topological information of a map is accurate.

Furthermore, because a driving trajectory of a vehicle is used, actual road conditions may be accurately reflected.

### DESCRIPTION OF DRAWINGS

FIG. 1 is a diagram for describing an example of a driving trajectory of a traveling vehicle and an image obtained from the traveling vehicle, according to an embodiment.

FIGS. 2A and 2B are exemplary diagrams for describing a method of determining a number-of-lanes change point and an intersection section as road feature information, according to an embodiment.

FIG. 3 is an exemplary diagram for describing a method of determining a U-turn section as road feature information, according to an embodiment.

FIG. 4 is an exemplary diagram for describing a method of determining an interchange/junction section as road feature information, according to an embodiment.

FIG. 5 is an exemplary diagram for describing a method of determining a position of a section node dividing a road on a road map into a plurality of sections based on road feature information, according to an embodiment.

FIGS. 6A to 6C are exemplary diagrams for describing a method of determining a lane placement for each section, according to an embodiment.

FIGS. 7A to 7D are exemplary diagrams for describing a method of correcting a lane centerline network within a section, according to an embodiment.

FIGS. 8A to 8B are exemplary diagrams for describing a method of grouping section nodes, according to an embodiment.

FIG. 9 is an exemplary diagram for describing a method of determining final longitudinal positions of section nodes in a node group, according to an embodiment.

FIG. 10 is an exemplary diagram for describing a method of determining a section network connection relationship, according to an embodiment.

FIGS. 11A and 11B are exemplary diagrams for describing a method of determining a geometry of lane placement for each section, according to an embodiment.

FIG. 12 is a diagram for describing an example of a lane centerline network according to an embodiment.

FIG. 13 is a flowchart of a lane centerline network determination method according to an embodiment.

FIG. 14 is a block diagram of a lane centerline network determination apparatus according to an embodiment.

### BEST MODE

The disclosure relates to a lane centerline network determination method and a lane centerline network determination apparatus. A lane centerline network determination method according to an embodiment of the disclosure may include obtaining a driving trajectory of a vehicle by using a global positioning system (GPS) mounted on the vehicle, matching a road map with the driving trajectory, generating road feature information considering the driving trajectory based on an image captured by an image capturing device mounted on the vehicle, determining a position of a section node dividing a road on the road map into a plurality of sections based on the road feature information, determining a lane centerline placement for each section by determining a lane centerline for the traveling lane of the vehicle among a plurality of lanes included in the section based on the driving trajectory, and estimating lane centerlines for remaining lanes, determining a final longitudinal position of the section node based on reliability of the section node for each of driving trajectories through which the vehicle has passed a same road repeatedly, determining a section network connection relationship between the section, a previous section, and a next section based on the lane centerline placement for each section, determining a geometry of the lane centerline placement for each section based on reliability of a section link connecting the section nodes to each other, and generating a lane centerline network based on the section network connection relationship and a lane centerline geometry within the section.

### MODE FOR INVENTION

Advantages and features of the disclosure, and methods of achieving them will be clarified with reference to embodiments described below in detail with reference to the accompanying drawings. However, it should be understood that the disclosure is not limited to the embodiments presented below, but may be implemented in various different forms and may include any modifications, equivalents, and substitutes included in the spirit and scope of the disclosure. Embodiments presented below are provided so that the disclosure will be thorough and complete and will fully convey the concept of the embodiments to those of ordinary skill in the art. In describing the disclosure, when the detailed description of the relevant known technology is determined to obscure the gist of the disclosure, the detailed description thereof may be omitted.

The terms as used in the present specification are only used to describe specific embodiments and are not intended to limit the disclosure. The singular forms as used herein are intended to include the plural forms as well unless the context clearly indicates otherwise. The terms “comprise,” “include,” or “have” as used in the present application are inclusive and therefore specify the presence of one or more stated features, integers, steps, operations, elements, components, or any combination thereof, but do not preclude the presence or addition of one or more other features, integers, steps, operations, elements, components, or any combination thereof.

Some embodiments of the present disclosure may be represented by functional block configurations and various processes. All or part of these functional blocks may be implemented in various numbers of hardware and/or software configurations that perform specific functions. For example, the functional blocks of the disclosure may be implemented by one or more microprocessors, or may be implemented by circuit configurations for certain functions. In addition, for example, the functional blocks of the present disclosure may be implemented in various programming or scripting languages. The functional blocks may be implemented by algorithms that are executed on one or more processors. In addition, the disclosure may employ a related art for electronic environment setting, signal processing, and/or data processing. The terms such as “mechanism,” “element,” “means,” and “configuration” may be used in a broad sense and are not limited to mechanical and physical configurations.

In addition, connecting lines or connecting members between elements illustrated in the drawings only exemplify functional connections and/or physical or circuit connections. In an actual device, a connection between elements may be represented by various functional connections, physical connections, or circuit connections that are replaceable or added.

Hereinafter, a “vehicle” may refer to any type of transportation, such as an automobile, a bus, a motorcycle, a scooter, or a truck, which is used to move people or objects with an engine.

Hereinafter, a “lane” may refer to a portion of a roadway divided by lanes so that vehicles pass through a designated portion of a road in one line. A “lane centerline” may refer to an imaginary line passing through the center of the “lane.”

A “lane centerline network determination apparatus” may be mounted on a vehicle 110. Alternatively, the “lane center line network determination apparatus” may be located outside the vehicle 110 and form a communication network with other devices (a global positioning system (GPS) receiver, a camera, etc.) located inside the vehicle 110 so as to exchange data. The “lane centerline network determination apparatus” may be implemented as a computer device or a plurality of computer devices that perform communication through a network to provide commands, codes, files, content, services, etc. Hereinafter, for convenience of explanation, it is assumed that the “lane centerline network determination apparatus” is mounted on the vehicle 110.

Hereinafter, the disclosure is described in detail with reference to the accompanying drawings.

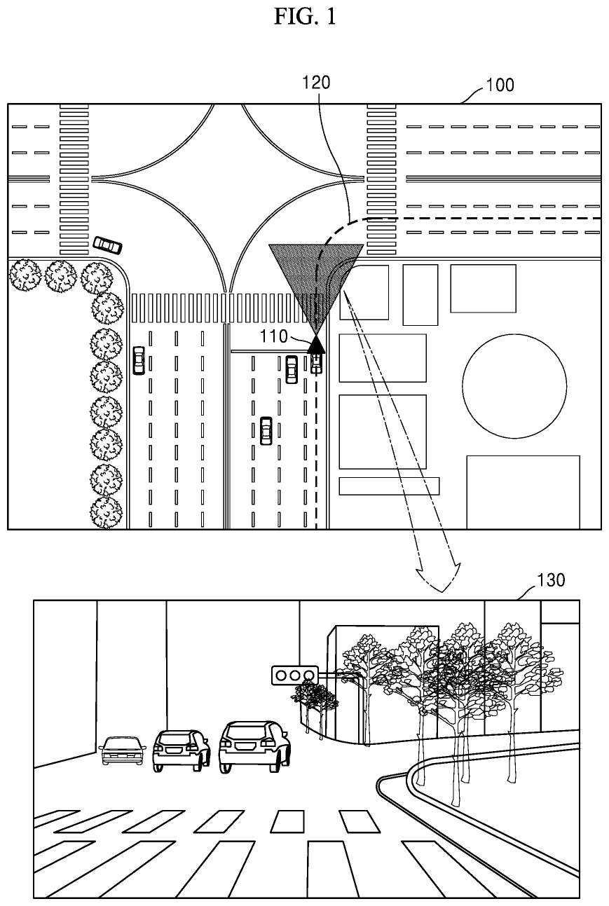

FIG. 1 is a diagram for describing an example of a driving trajectory of a traveling vehicle and an image obtained from the traveling vehicle, according to an embodiment.

Referring to FIG. 1, a GPS receiver may be mounted on a traveling vehicle 110. The GPS receiver may receive a GPS signal from an artificial satellite. The GPS receiver mounted on the vehicle 110 may obtain, from the GPS signal, GPS location information including information about a latitude and a longitude of the vehicle 110. In addition, a lane centerline network determination apparatus mounted on the vehicle 110 may generate a driving trajectory 120 of the vehicle 110 by concatenating GPS position information.

The driving trajectory 120 of the vehicle 110 may match a road map 100. The lane centerline network determination apparatus may match the driving trajectory 120 of the vehicle 110 with the road map 100 by matching position information stored in the road map 100 with position information of the driving trajectory 120.

In addition, an image capturing device such as a camera may be mounted on the traveling vehicle 110. The image capturing device may capture an image of surroundings of the vehicle 110. Referring to FIG. 1, an image 130 captured while the vehicle 110 is traveling is illustrated. Although only the image 130 captured by the image capturing device mounted on the front of the vehicle 110 is illustrated in FIG. 1, an image capturing device that captures an image of the side, rear, and surround views of the vehicle 110 may be additionally mounted on the vehicle 110.

The image capturing device may transmit the captured image 130 to the lane centerline network determination apparatus.

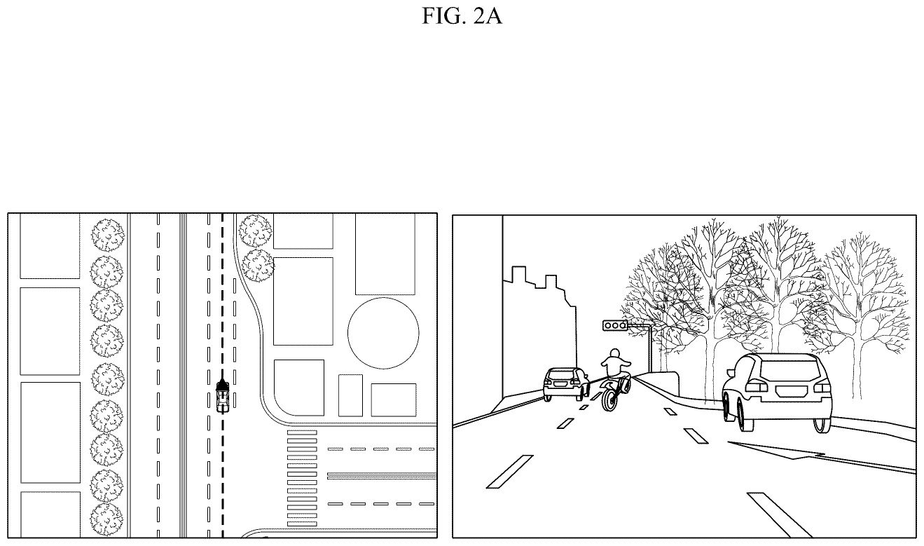

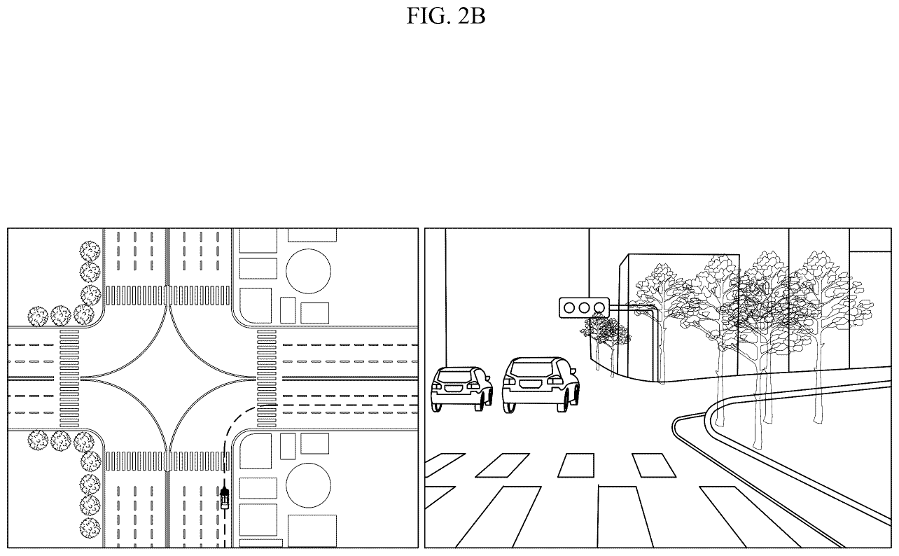

The lane centerline network determination apparatus may generate road feature information by considering the driving trajectory 120 based on the image 130 captured by the image capturing device. This is described in detail with reference to FIG. 2.

FIGS. 2A and 2B are exemplary diagrams for describing a method of determining a number-of-lanes change point and an intersection section as road feature information, according to an embodiment.

In an embodiment, the road feature information may include at least one of a number-of-lanes change point, an intersection section, a U-turn section, and an interchange/junction section.

Referring to FIG. 2A, the lane centerline network determination apparatus may determine a number-of-lanes change point while the vehicle is traveling by calculating the number of left and right lanes at certain time intervals with respect to the current traveling lane of the vehicle. For example, when the vehicle is traveling in the same lane and there is a point where the rightmost lane merges with the adjacent left lane, the lane centerline network determination apparatus may determine the merge point as the point where the road feature information changes.

Referring to FIG. 2B, the lane centerline network determination apparatus may determine an intersection section. The lane centerline network determination apparatus may analyze an object within an image captured by the image capturing device mounted on the vehicle. When the object is identified as a traffic light, a crosswalk, or a stop line, the lane centerline network determination apparatus may determine that a point where the image was captured corresponds to the intersection section. The lane centerline network determination apparatus may determine a point where the intersection section begins or ends as the point where road feature information changes.

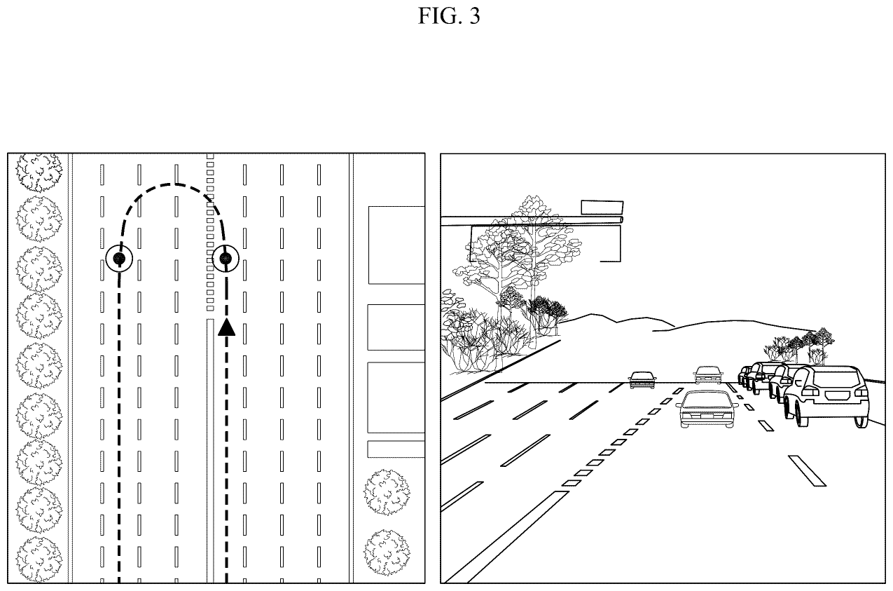

FIG. 3 is an exemplary diagram for describing a method of determining a U-turn section as road feature information, according to an embodiment.

The lane centerline network determination apparatus may determine the U-turn section based on a curvature value of a driving trajectory of a vehicle.

Specifically, referring to FIG. 3, the lane centerline network determination apparatus may calculate curvature values at a plurality of points on the driving trajectory of the vehicle. In addition, the lane centerline network determination apparatus may select, as a candidate section, a section in which the calculated curvature values are greater than or equal to a threshold value and the turning directions are the same. In addition, when the angle change of the candidate section is similar to a preset U-turn trajectory, the lane centerline network determination apparatus may determine the candidate section as the U-turn section.

The lane centerline network determination apparatus may determine a point where the U-turn section begins or ends as the point where road feature information changes.

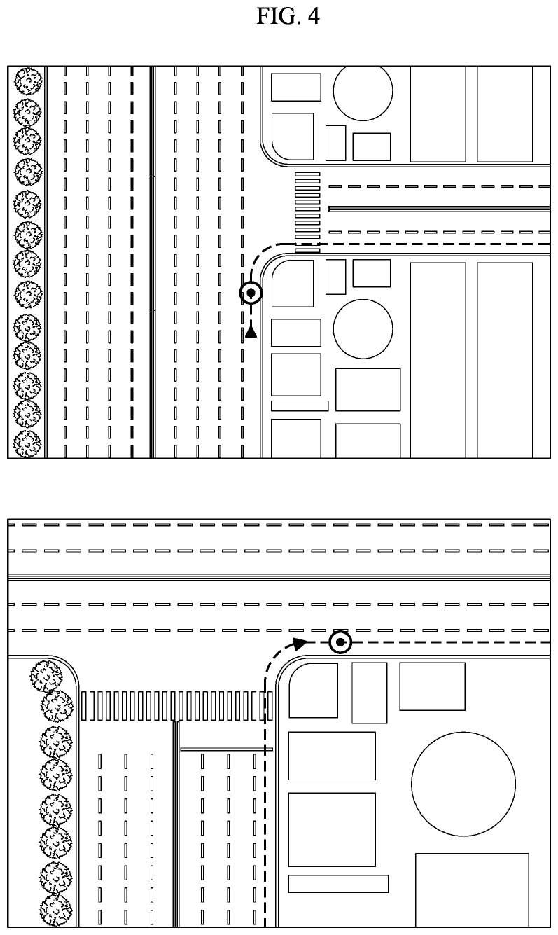

FIG. 4 is an exemplary diagram for describing a method of determining an interchange/junction section as road feature information, according to an embodiment.

The lane centerline network determination apparatus may determine a U-turn section based on a curvature value of a driving trajectory of a vehicle.

Specifically, referring to FIG. 4, the lane centerline network determination apparatus may calculate curvature values at a plurality of points on the driving trajectory of the vehicle. In addition, the lane centerline network determination apparatus may select, as a candidate section, a section in which the calculated curvature values are greater than or equal to a threshold value and the turning directions are the same. In addition, when the angle change of the candidate section corresponds to a left or right turn and the object in the image captured by the image capturing device mounted on the vehicle is identified as a crosswalk, the lane centerline network determination apparatus may determine the candidate section as the interchange/junction section.

The lane centerline network determination apparatus may determine a point where the interchange/junction section begins or ends as the point where road feature information changes.

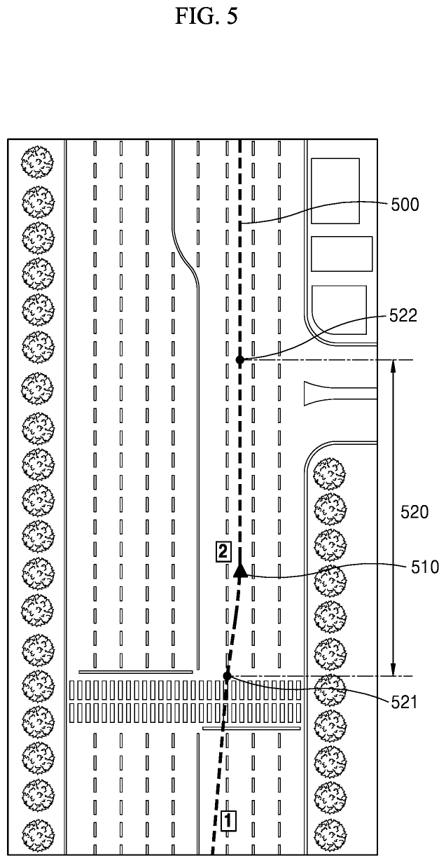

FIG. 5 is an exemplary diagram for describing a method of determining a position of a section node dividing a road on a road map into a plurality of sections based on road feature information, according to an embodiment.

When a change in road feature information of a road on which a vehicle 510 is traveling is detected, the lane centerline network determination apparatus may divide sections of the road based on the detected point.

Referring to FIG. 5, a case where road feature information changes at a first point 521 and a second point 522 while the vehicle 510 is traveling along a driving trajectory 500 is illustrated. Specifically, because the lane change of the vehicle 510 occurred at the first point 521 and the change in the number of lanes on the road occurred at the second point 522, the lane centerline network determination apparatus may detect that road feature information has changed at the first point 521 and the second point 522.

The lane centerline network determination apparatus may determine, as section nodes, the first point 521 and the second point 522 where the road feature information has changed, and may divide the section 520 based on the determined section nodes. On the other hand, a line connecting the first point 521 and the second point 522, which are the nodes of the section 520, to each other may be referred to as a section link. That is, the section 520 may include section nodes and a section link connecting the section nodes to each other.

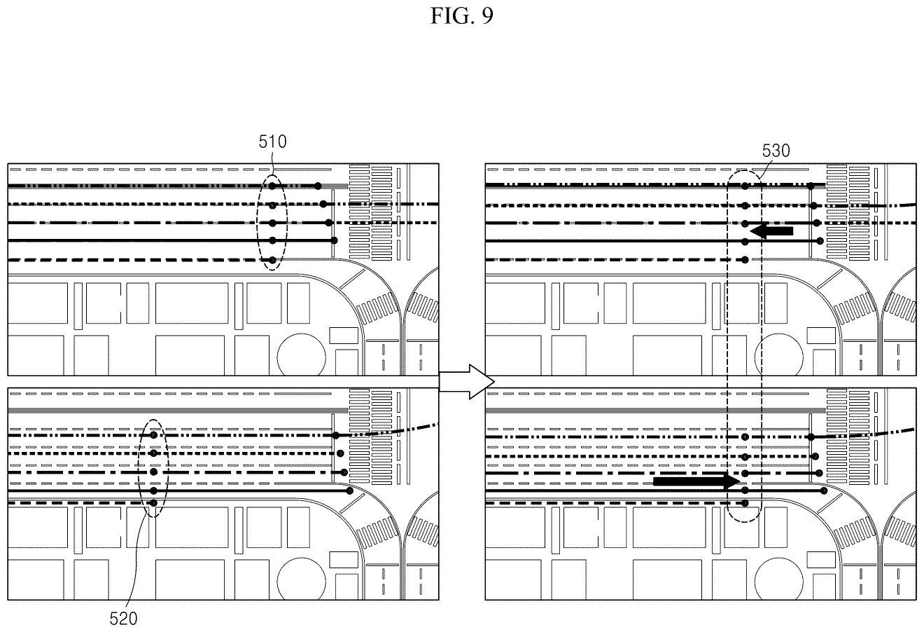

In an embodiment, the lane centerline network determination apparatus may determine the reliability of the section node. The reliability of the section node may affect the determination of the longitudinal position of the section node in FIG. 9 below.

The reliability of the section node may be determined by the accuracy weight and reliability of the road feature information.

The reliability of the road feature information may vary whenever the road feature information is generated. For example, the reliability of the road feature information may be determined by factors that affect the detection accuracy of the road feature information (resolution, distance from object, surrounding brightness, etc.).

The accuracy weight may be determined considering the traveling lane of the vehicle. For example, the accuracy weight may be determined to be highest for the traveling lane of the vehicle, and the accuracy weight may be determined to be lower for a lane located farther away from the traveling lane. In addition, when the traveling lane of the vehicle changes or the vehicle is turning, the accuracy weight may be determined to be low.

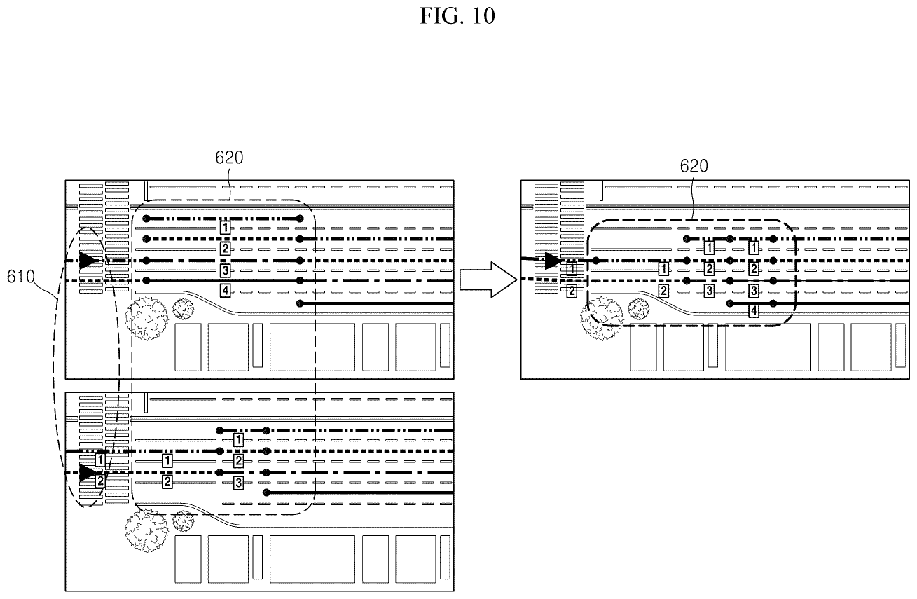

In an embodiment, the lane centerline network determination apparatus may determine the reliability of the section link. The reliability of the section link may affect the determination of the road type, such as the final number of lanes and intersections, when merging the section links in FIG. 10 below.

The reliability of the section link may be determined by the section link weight and reliability of the road feature information.

The reliability of the road feature information may vary whenever the road feature information is generated. For example, the reliability of the road feature information may be determined by factors that affect the detection accuracy of the road feature information (resolution, distance from object, surrounding brightness, etc.).

The section link weight may be adjusted to be lower as the detection rate of the number of lanes is lower due to the lane change, etc.

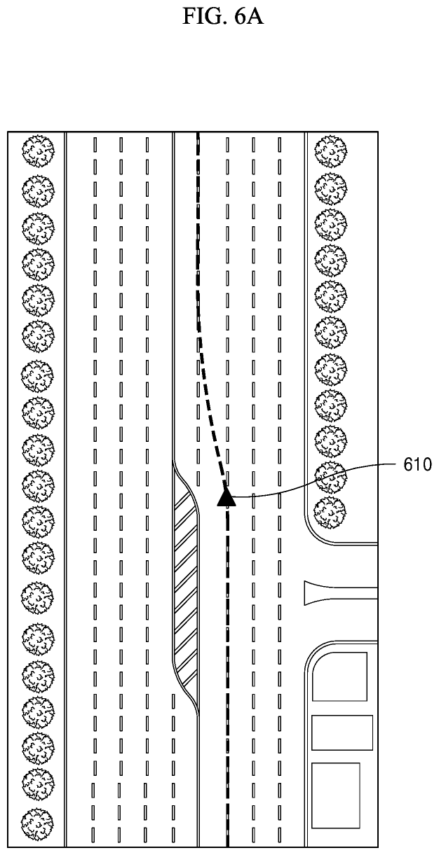

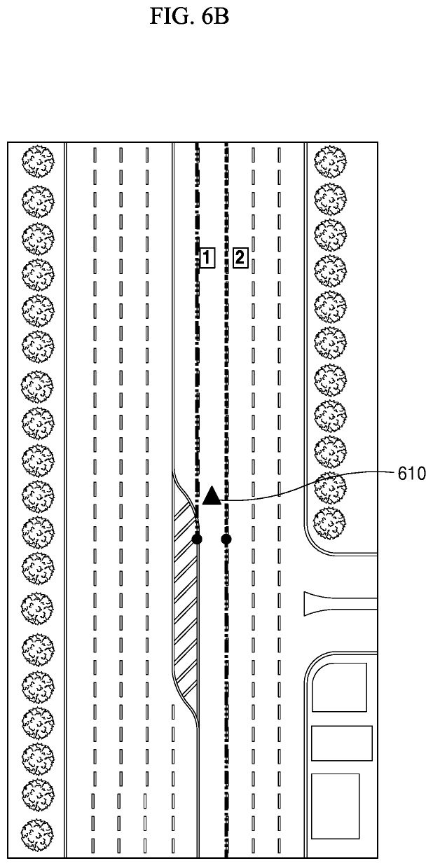

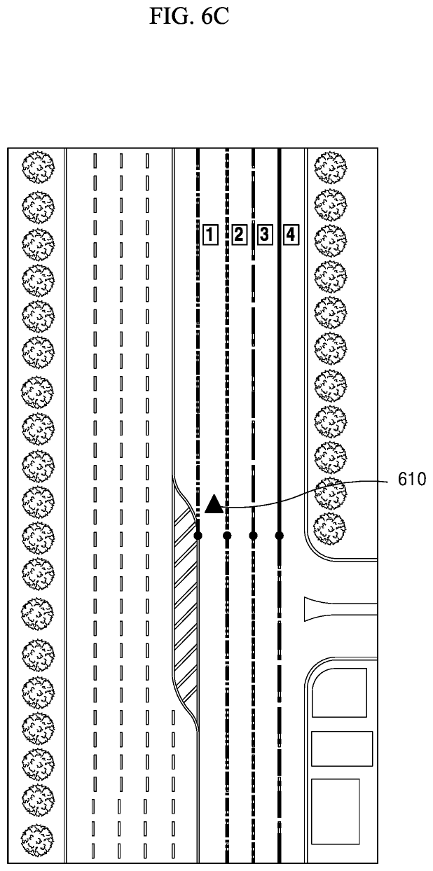

FIGS. 6A to 6C are exemplary diagrams for describing a method of determining lane placement for each section, according to an embodiment.

The lane centerline network determination apparatus may determine a lane centerline for a lane in which a vehicle 610 has passed on a section basis. For example, when the vehicle 610 continues to travel in the second lane, the lane centerline network determination apparatus may determine the lane centerline for the second lane.

In addition, when the lane change of the vehicle 610 occurs, the lane centerline network determination apparatus may determine the lane centerline for the lane after the change based on the current driving trajectory, and may determine the lane centerline for the lane before the change by linearly estimating the past driving trajectory.

Referring to FIGS. 6A and 6B, a case where the vehicle 610 is traveling in the second lane and then changes to the first lane in the middle is illustrated. In this case, the lane centerline network determination apparatus may determine the lane centerline for the first lane based on the current driving trajectory, and may determine the lane centerline for the second lane by linearly estimating the past driving trajectory.

In addition, in the case of a lane centerline for a non-traveling lane, the lane centerline network determination apparatus may determine the lane placement for each section by replicating the lane centerline for the traveling lane in the lateral direction and estimating the lane centerlines for the remaining non-traveling lanes.

Referring to FIG. 6C, because the vehicle 610 changes from the second lane to the first lane, the lane centerline network determination apparatus may estimate the lane centerlines for third and fourth non-traveling lanes by replicating the lane centerlines for the first and second lanes in the lateral direction.

Through the processes described above, the lane centerline network determination apparatus may determine the lane centerline placement in the corresponding section.

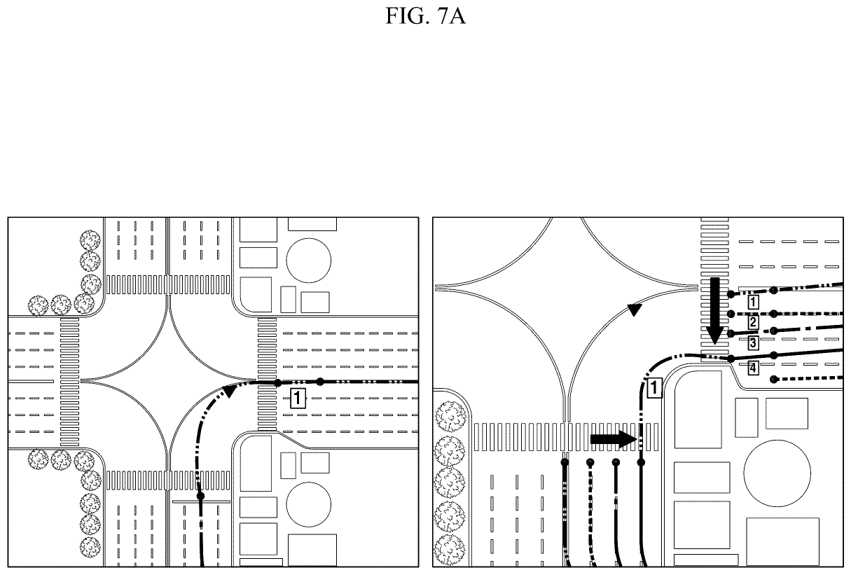

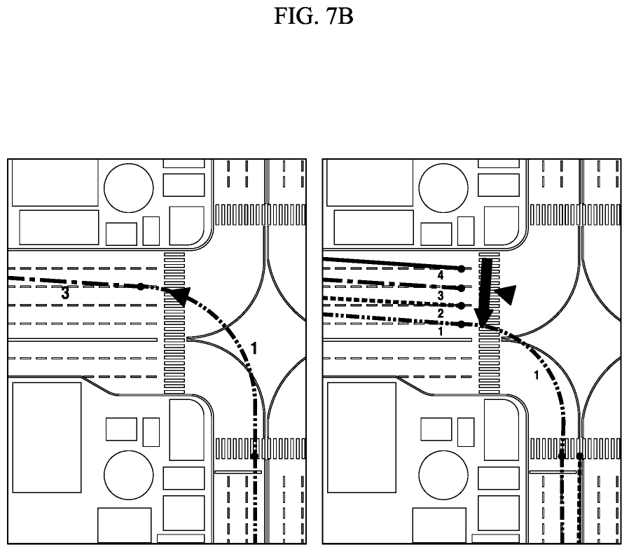

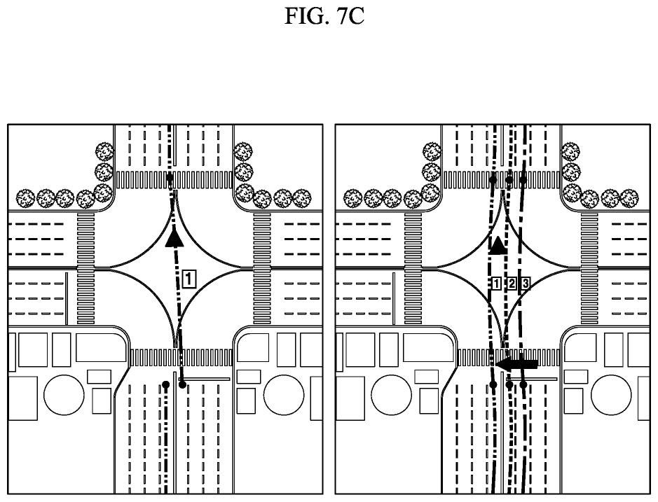

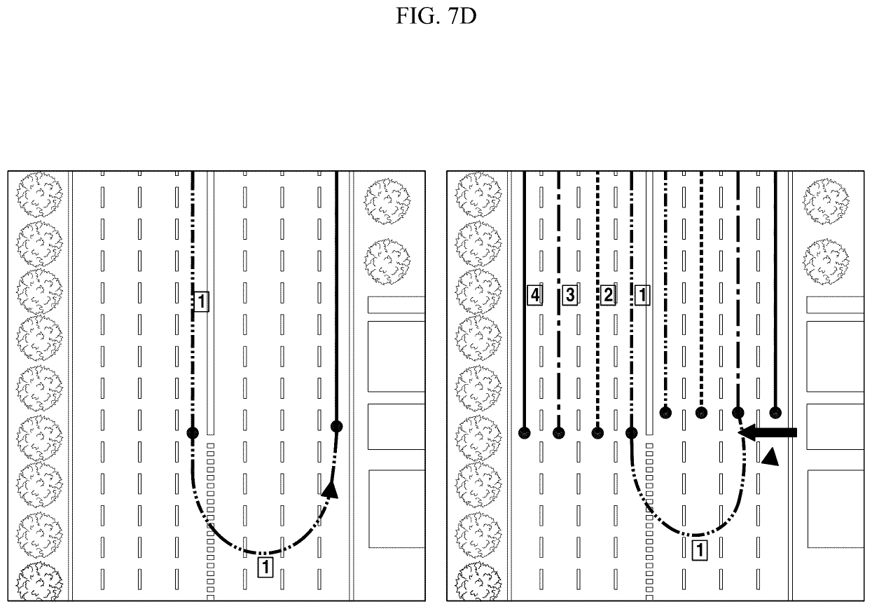

FIGS. 7A to 7D are exemplary diagrams for describing a method of correcting a lane centerline network in a section, according to an embodiment.

When certain road feature information is generated, the lane centerline network determination apparatus may correct the lane centerline network within the section based on a preset criterion. The certain road feature information may include an intersection section, a U-turn section, etc. In other words, because the lane centerline is not marked in the intersection section and the U-turn section, the lane is unclear, and accordingly, it is impossible to confirm whether the lane has changed. Therefore, the lane centerline network within the section needs to be corrected based on the preset criterion.

In an embodiment, when the road feature information is an intersection section or a U-turn section, the lane centerline network determination apparatus may determine (or correct) the lane centerline network within the section by applying intersection traffic rules or U-turn traffic rules regardless of the driving trajectory of the vehicle.

Referring to FIG. 7A, an example in which a vehicle turns right at an intersection is illustrated. Even when the vehicle actually enters from the third lane and exits to the first lane, the lane centerline network determination apparatus may determine the lane centerline network within the section so that the vehicle enters from the fourth lane and exits to the fourth lane.

Referring to FIG. 7B, an example in which a vehicle turns left at an intersection is illustrated. Even when the vehicle actually enters from the first lane and exits to the third lane, the lane centerline network determination apparatus may determine the lane centerline network within the section so that the vehicle enters from the first lane and exits to the first lane.

Referring to FIG. 7C, an example in which a vehicle goes straight at an intersection is illustrated. The lane centerline network within the section may be determined so that the vehicle enters and exits in the most straight connection method.

Referring to FIG. 7D, an example in which a vehicle makes a U-turn is illustrated. Even when the vehicle actually enters from the fourth lane and exits to the fourth lane, the lane centerline network determination apparatus may determine the lane centerline network within the section so that the vehicle enters from the fourth lane and exits to the third lane.

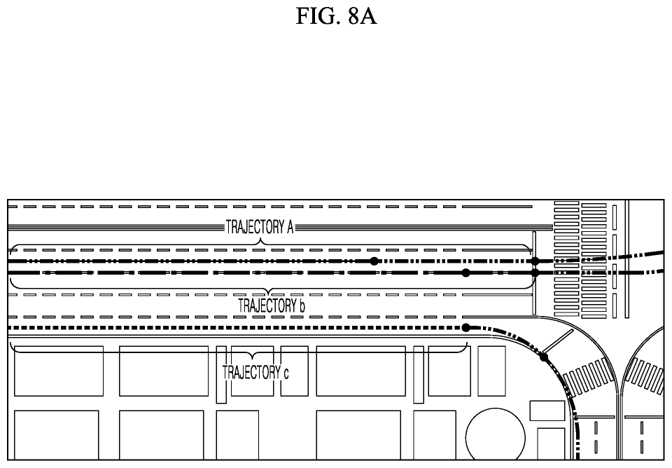

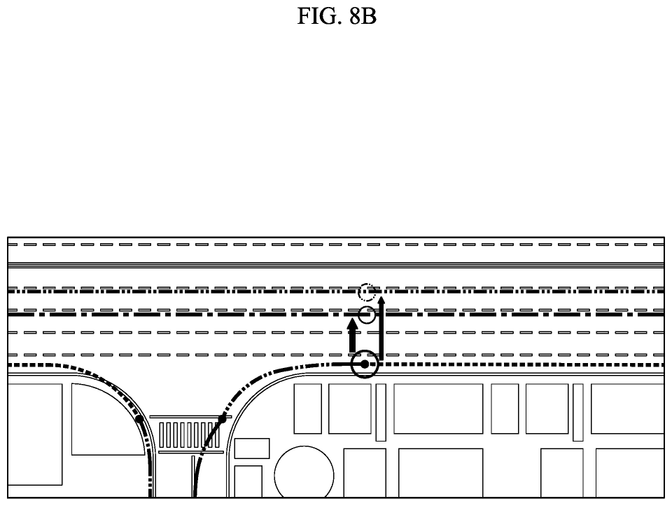

FIGS. 8A to 8B are exemplary diagrams for describing a method of grouping section nodes, according to an embodiment.

Referring to FIGS. 8A and 8B, driving trajectories of three vehicles passing the same road in different lanes are illustrated. Specifically, trajectory A may be a trajectory in which vehicle A travels in the first lane, trajectory B may be a trajectory in which vehicle B travels in the second lane, and trajectory C may be a trajectory in which vehicle C travels in the fifth lane.

In an embodiment, the lane centerline network determination apparatus may extract, as a node list, section nodes generated from the driving trajectories estimated to have traveled the same road based on a certain criterion. The certain criterion may include map matching information of the road, shape features such as the direction and distance of the road, and relational similarity, but is not limited thereto.

On the other hand, the lane centerline network determination apparatus may extract a section link list for trajectories estimated to have passed through the same road based on the node list. The section link list may be subject to merging of a next section link and a lane centerline.

The lane centerline network determination apparatus may track section links and designate, as a node group, section nodes in the node list that are located within a certain distance. Referring to FIG. 8A, the lane centerline network determination apparatus may designate, as a node group, two section nodes near an intersection entry stop line located within a certain distance.

Road feature information corresponding to the section to which the certain section node belongs may match the certain section node. Feature information of the section node may include a change in the number of lanes, an intersection section, a U-turn section, a road interchange/junction section, etc.

The lane centerline network determination apparatus may designate, as a node group, section nodes in the node list that are located within a certain distance and have the same road feature information. Referring to FIG. 8A, the lane centerline network determination apparatus may designate, as a node group, two section nodes near the intersection entry stop line which are located within a certain distance and have the same road feature information as that of the intersection section.

On the other hand, when no matching section node is found in the trajectory, the lane centerline network determination apparatus may insert a section node into a section link with a similar direction and a shortest distance and may separate the lane centerline. Referring to FIG. 8B, because there is no node matching the section node indicating the road junction section in the two section links, the lane centerline network determination apparatus may insert the section node indicating the road junction section into the two section links and may separate the lane centerline.

In an embodiment, the lane centerline network determination apparatus may remove at least some of the section nodes from the node group. Specifically, the lane centerline network determination apparatus may remove section nodes that are incorrectly matched due to trajectory position errors, misdetection of road features, etc.

For example, the lane centerline network determination apparatus may remove, from the section nodes in the node group, section nodes whose front/back position relationships are different based on the intersection section included in the road feature information.

In addition, when a certain section node belongs to a plurality of node groups, the lane centerline network determination apparatus may designate, as a node group of the certain section node, a node group that has a high road feature information similarity to the certain section node and a closer distance to the certain section node. That is, the certain section node may be removed from an unspecified node group.

FIG. 9 is an exemplary diagram for describing a method of determining final longitudinal positions of section nodes in a node group, according to an embodiment.

Referring to FIG. 9, it is assumed that a first section node 510 and a second section node 520 belong to the same node group.

While FIGS. 8A to 8D illustrate only the section nodes for the lanes in which the vehicles have traveled, FIG. 9 illustrates that the lane centerline for the lane in which the vehicle has traveled and the lane centerlines for the remaining lanes other than the lane in which the vehicle has traveled, and illustrates the nodes of the respective lane centerlines.

The lane centerline network determination apparatus may determine the final longitudinal position of the representative section node 530, which merges the section nodes 510 and 520 in the node group, by using the node reliability of each of the section nodes 510 and 520 included in the node group as a weight. In FIG. 9, the representative section node 530 is illustrated as a plurality of nodes. However, because the representative section node 530 includes information about the longitudinal position on the road, the representative section node 530 may be marked as a single node.

The reliability of the section node may be determined by the accuracy weight and reliability of the road feature information.

The reliability of the road feature information may vary whenever the road feature information is generated. For example, the reliability of the road feature information may be determined by factors that affect the detection accuracy of the road feature information (resolution, distance from object, surrounding brightness, etc.).

The accuracy weight may be determined considering the traveling lane of the vehicle. For example, the accuracy weight may be determined to be highest for the traveling lane of the vehicle, and the accuracy weight may be determined to be lower for a lane located further away from the traveling lane. In addition, when the traveling lane of the vehicle changes or the vehicle is turning, the accuracy weight may be determined to be low.

The lane centerline network determination apparatus may correct and match the longitudinal positions of the lane centers of the sections to be merged based on the final longitudinal position of the representative section node.

In addition, the lane centerline network determination apparatus may correct the final longitudinal position of the representative section node so that the front/rear section length of the representative section node is greater than or equal to a certain length.

In addition, the lane centerline network determination apparatus may determine the road feature information of the representative section node based on reliability of the section nodes included in the node group and road feature information matched with the nodes. For example, when the road feature information of nine section nodes among ten section nodes included in the node group is an intersection section and the road feature information of one section node is a pocket section, the lane centerline network determination apparatus may determine the road feature information of the representative section node as an intersection section.

FIG. 10 is an exemplary diagram for describing a method of determining a section network connection relationship, according to an embodiment.

In an embodiment, the lane centerline network determination apparatus may determine a section network connection relationship between a reference section, a previous section, and a next section based on the lane centerline placement for each section.

Specifically, the lane centerline network determination apparatus may select an anchor section with a highest reliability among a plurality of sections. For example, the lane centerline network determination apparatus may designate, as a link group, links connected to the representative section node. In addition, the lane centerline network determination apparatus may select, as an anchor section, a section corresponding to a link group with a highest reliability among a plurality of link groups based on a certain criterion. The certain criterion may include, for example, whether the number of lanes in the section link group matches, whether the number of lanes in the front/rear sections matches, the maximum number of lanes, etc.

Referring to FIG. 10, because a first section link group 610 has a smallest number of lane centerlines and the numbers of lanes also match each other, the section corresponding to the first section link group 610 may be an anchor section.

The lane centerline network determination apparatus may connect a previous section to a next section based on the anchor section.

Specifically, the lane centerline network determination apparatus may assign the lane numbers of the front/rear sections based on the lane number of the anchor section. For example, in FIG. 10, lane numbers 1, 2, 3, and 4 may be respectively changed to −1, 0, 1, and 2 so as to correspond to the lane numbers of the anchor section.

In addition, the lane centerline network determination apparatus may calculate the probability (possibility of lane existence) for each lane with respect to each section, and the probability may decrease as the distance from the traveling lane increases. For example, in the case of the section generated when the vehicle travels in a first lane on a three-lane road, the probability of lane existence is 100% for the first lane, 75% for the second lane, and 50% for the third lane, and the possibility of lane non-existence is-25% for the fourth lane and −75% for the zeroth lane. The lane centerline network determination apparatus may obtain the final number of lanes by additionally considering the reliability of the section link described with reference to FIG. 5 and excluding lanes where the sum of the probabilities is less than 0%. For example, in FIG. 10, because the number of lanes in the anchor section is two, the final number of lanes in the next section 620 connected to the anchor section may also be determined to be two.

In an embodiment, the lane centerline network determination apparatus may repeatedly determine the final number of lanes for the connected front/rear section link groups. When there is no connected section link group, the lane centerline network determination apparatus may repeatedly merge the number of lanes of the section link group with the next highest reliability. In addition, the lane centerline network determination apparatus may differentially apply the influence of the side closer to the traveling lane and quickly and accurately complete the lane structure by traveling on both end lanes.

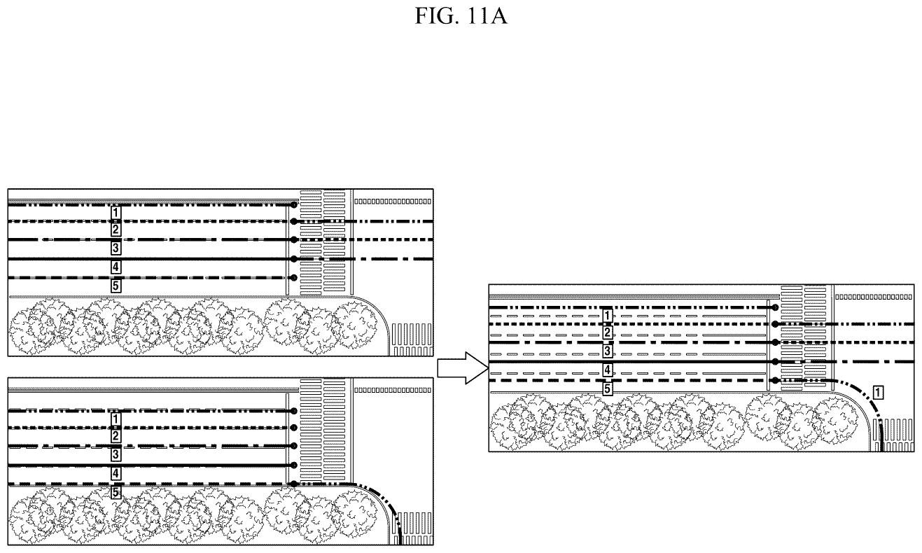

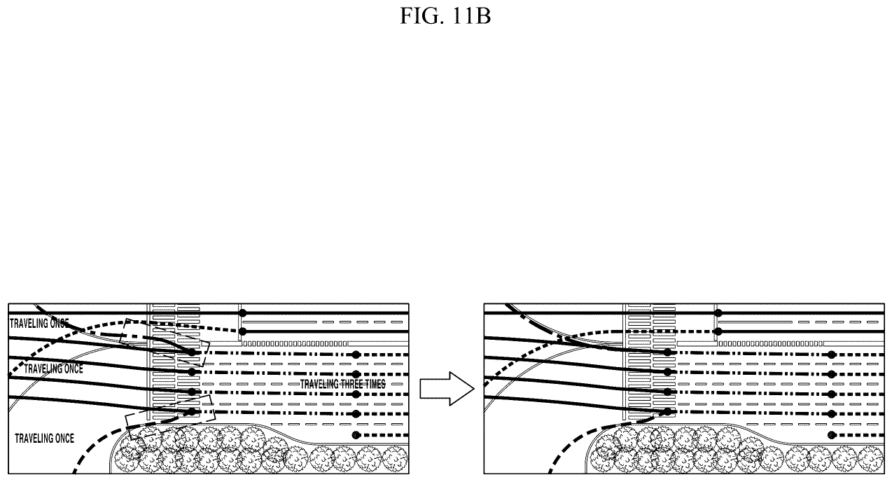

FIGS. 11A and 11B are exemplary diagrams for describing a method of determining a geometry of lane placement for each section, according to an embodiment.

In an embodiment, the lane centerline network determination apparatus may adjust the lateral position of the lane centerline within the section by determining a higher linear weight for the lane centerline that is closer to the traveling lane of the vehicle. In addition, the lane centerline network determination apparatus may determine the lane centerline geometry within the section according to the adjusted lateral position.

Referring to FIG. 11A, the geometry of the lane centerline placement may be determined by combining the sections based on the lane centerline linear weight.

The lane centerline network determination apparatus may reflect the lane centerline reliability, in which the linear weight decreases as the lane centerline is farther away from the traveling lane of the vehicle, and the lane centerline linear accuracy of the section, which decreases as linear distortion occurs. In other words, as the distance to the traveling lane decreases, the lane centerline linearity influence is differentially applied. Accordingly, asymmetrical lane generation and linear accuracy may be quickly secured.

In addition, the lane centerline network determination apparatus may determine the lane centerline geometry within the section by removing steps that occur at the connecting portion between the sections.

Referring to FIG. 11B, the lane centerline network determination apparatus may generate the final lane centerline geometry by removing the lateral step between the front/rear lane centerlines that occurs near the intersection. For example, when the vehicle travels on the same general road three times by going straight/turning left/turning right at the intersection each time, steps occur at the intersection and the general roads due to different combinations of trajectories. However, the steps may be removed by smooth interpolation using the method described above.

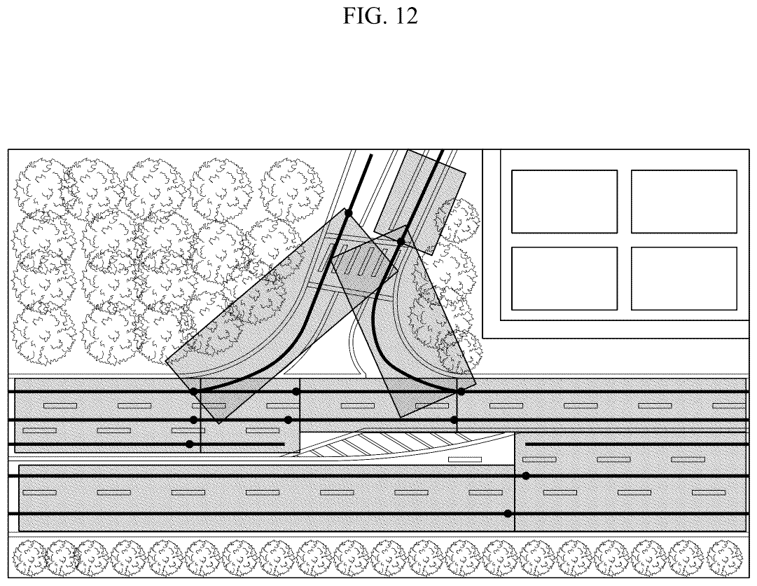

FIG. 12 is a diagram for describing an example of a lane centerline network according to an embodiment.

The lane centerline network determination apparatus may generate the lane centerline network based on the section network connection relationship and the lane centerline geometry within the section, which have been described above with reference to FIGS. 1 to 11.

Referring to FIG. 12, lane centerline links are indicated by black lines, section nodes are indicated by dots, and sections are indicated by boxes.

On the other hand, the number of trips per section may be additionally considered in various evaluation criteria used in the process of generating the lane centerline network.

Specifically, when the node reliability of each of a plurality of section nodes included in a node group is used as a weight, the number of trips per section may be additionally considered in the weight. In addition, as the number of trips per section increases, the longitudinal position of the section node may be more greatly affected. In addition, the number of trips per section may be additionally considered in correcting the longitudinal positions of the section and lane centerline. For example, when the junction of the section is encountered, the longitudinal position may be corrected in the same method for all section links of the forked road. In addition, the number of trips per section may be additionally considered to determine road feature information of the representative section node. In addition, the number of driving visits of the section link may be applied to the possibility of lane existence or the possibility of lane non-existence as the weight. In addition, when the connection relationships of the sections to be merged are different from each other, the number of driving visits of the section link may be added as the weight when selecting the connection relationship. Furthermore, the number of driving visits of the section link may be added to the linear weight of the lane centerline.

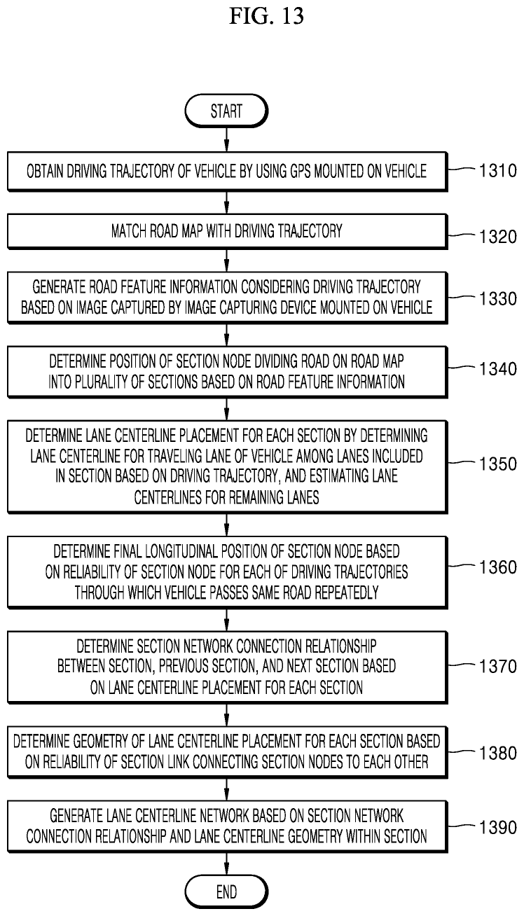

FIG. 13 is a flowchart of a lane centerline network determination method according to an embodiment.

The lane centerline network determination method illustrated in FIG. 13 is related to the embodiments provided with reference to the drawings described above. Accordingly, even when omitted below, the descriptions provided with reference to the drawings described above may also be applied to the method of FIG. 13.

Referring to FIG. 13, in operation 1310, the processor may obtain the driving trajectory of the vehicle by using the GPS mounted on the vehicle.

In operation 1320, the processor may match the road map with the driving trajectory.

In operation 1330, the processor may generate road feature information considering the driving trajectory based on the image captured by the image capturing device mounted on the vehicle.

The road feature information may include at least one of a number-of-lanes change point, an intersection section, a U-turn section, and an interchange/junction section.

The processor may calculate curvature values at a plurality of points on the driving trajectory of the vehicle, may select, as a candidate section, a section in which the calculated curvature values are greater than or equal to a threshold and the turning directions are the same, and may determine the candidate section as a U-turn section when the angle change of the candidate section is similar to a preset U-turn trajectory.

In addition, the processor may calculate curvature values at a plurality of points on the driving trajectory of the vehicle, may select, as a candidate section, a section in which the calculated curvature values are greater than or equal to a threshold and the turning directions are the same, and may determine the candidate section as an interchange/junction section when the angle change of the candidate section corresponds to a left or right turn and the object in the image captured by the image capturing device mounted on the vehicle is identified as a crosswalk.

In operation 1340, the processor may determine the position of the section node dividing a road on a road map into a plurality of sections based on the road feature information.

The section may include section nodes and a section link connecting the section nodes to each other.

When the change in road feature information is detected, the processor may determine the detected point as the section node and divide the sections based on the determined section node.

The processor may determine the reliability of the section node. The reliability of the section node may be determined by the accuracy weight considering the reliability of the road feature information and the traveling lane. The accuracy weight may be determined to be highest for the traveling lane of the vehicle, and the accuracy weight may be determined to be lower for a lane located farther away from the traveling lane. When the traveling lane of the vehicle changes or the vehicle is turning, the accuracy weight may be determined to be low.

The processor may determine the reliability of the section link. The reliability of the section link may be determined by the section link weight and reliability of the road feature information. As the detection rate of the number of lanes decreases, the link accuracy weight may be determined to be lower.

In operation 1350, the processor may determine the lane centerline placement for each section by determining the lane centerline for the traveling lane of the vehicle among the lanes included in the section based on the driving trajectory, and estimating the lane centerlines for the remaining lanes.

When the road feature information is an intersection section or a U-turn section, the processor may determine the lane centerline placement within the section by applying intersection traffic rules or U-turn traffic rules regardless of the driving trajectory of the vehicle.

In operation 1360, the processor may determine the final longitudinal position of the section node based on the reliability of the section node for each of the driving trajectories through which the vehicle passes the same road repeatedly.

The processor may extract, as a node list, section nodes generated from the driving trajectories estimated to have traveled the same road based on a certain criterion. Road feature information corresponding to the section to which the certain section node belongs may match the certain section node.

The processor may track section links and designate, as a node group, section nodes in the node list that are located within a certain distance.

The processor may designate, as a node group, section nodes in the node list that are located within a certain distance and have the same road feature information.

When there is no section node having the same road feature information within a certain distance, the processor may insert the certain section node into a section link with a similar direction and a shortest distance and may separate a lane centerline.

The processor may remove, from the section nodes in the node group, section nodes whose front/back position relationships are different based on the intersection section included in the road feature information.

When a certain section node belongs to a plurality of node groups, the processor may designate, as a node group of the certain section node, a node group that has a high road feature information similarity to the certain section node and a closer distance to the certain section node.

In operation 1370, the processor may determine a section network connection relationship between a section, a previous section, and a next section based on the lane centerline placement for each section.

The processor may determine the final longitudinal position of the representative section node, which merges the section nodes in the node group, by using the node reliability of each of the section nodes included in the node group as a weight.

The processor may correct the final longitudinal positions of the section nodes in the node group so that the front/rear section length of the representative section node is greater than or equal to a certain length.

The processor may determine the road feature information of the representative section node based on reliability of the section nodes included in the node group and road feature information matched with the section nodes.

The processor may designate the links connected to the representative section node as the link group, may select, as the anchor section, the section corresponding to the link group with the highest reliability among the link groups based on a certain criterion, and may determine the section network connection relationship between the previous section and the next section based on the selected anchor section.

The processor may determine the reliability of the link group by determining higher possibility of the lane existence as the lane is closer to the traveling lane of the vehicle.

In operation 1380, the processor may determine the geometry of the lane centerline placement for each section based on the reliability of the section link connecting the section nodes to each other.

The processor may adjust the lateral position of the lane centerline within the section by determining a higher linear weight for the lane centerline that is closer to the traveling lane of the vehicle, and may determine the lane centerline geometry within the section according to the adjusted lateral position.

The processor may determine the lane centerline geometry within the section by removing steps that occur at the connecting portion between the sections.

In operation 1390, the processor may generate the lane centerline network based on the section network connection relationship and the lane centerline geometry within the section.

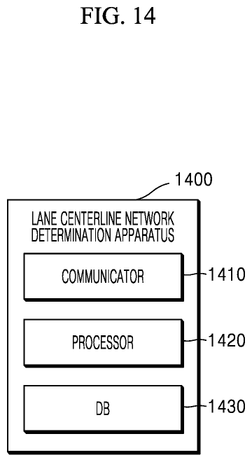

FIG. 14 is a block diagram of a lane centerline network determination apparatus according to an embodiment.

Referring to FIG. 14, a lane centerline network determination apparatus 1400 may include a communicator 1410, a processor 1420, and a database (DB) 1430. In the lane centerline network determination apparatus 1400 of FIG. 14, only elements related to the embodiment are illustrated. Accordingly, those of ordinary skill in the art will understand that other general-purpose elements may be included in addition to the elements illustrated in FIG. 14.

The communicator 1410 may include one or more elements that enable wired/wireless communication with an external server or an external device. For example, the communicator 1410 may include at least one of a short-range communicator (not shown), a mobile communicator (not shown), and a broadcast receiver (not shown).

The DB 1430 is hardware that stores various data processed in the lane centerline network determination apparatus 1400, and may store a program for processing and control by the processor 1420. The DB 1430 may store payment information, user information, etc.

The DB 1430 may include random access memory (RAM) (e.g., dynamic random access memory (DRAM), static random access memory (SRAM), etc.), read-only memory (ROM), electrically erasable programmable read-only memory (EEPROM), compact-disc random access memory (CD-ROM), Blu-ray or other optical disk storage, hard disk drive (HDD), or solid state drive (SSD).

The processor 1420 may control overall operations of the lane centerline network determination apparatus 1400. For example, the processor 1420 may control overall operations of an inputter (not shown), a display (not shown), the communicator 1410, the DB 1430, etc. by executing programs stored in the DB 1430. The processor 1420 may control the operation of the lane centerline network determination apparatus 1400 by executing programs stored in the DB 1430.

The processor 1420 may control at least a portion of the operation of the lane centerline network determination apparatus 1400 described with reference to FIGS. 1 to 13.

The processor 1120 may be implemented by using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and electrical units for executing other functions.

In an embodiment, the lane centerline network determination apparatus 1400 may be a mobile electronic device. For example, a traffic information providing device may be implemented as smartphones, tablet personal computers (PCs), PCs, smart TVs, personal digital assistants (PDAs), laptops, media players, navigation systems, camera-mounted devices, and other mobile electronic devices. In addition, the lane centerline network determination apparatus 1400 may be implemented as a wearable device (e.g., a watch, glasses, a hair band, or a ring) having a communication function and a data processing function.

In another embodiment, the lane centerline network determination apparatus 1400 may be an electronic device embedded in a vehicle. For example, the lane centerline network determination apparatus 1400 may be an electronic device inserted into a vehicle through tuning after a production process.

In another embodiment, the lane centerline network determination apparatus 1400 may be a server located outside a vehicle. The server may be implemented as a computer device or a plurality of computer devices that perform communication through a network to provide commands, codes, files, content, services, etc. The server may receive data necessary to determine a moving path of a vehicle from devices mounted on the vehicle, and may determine the moving path of the vehicle based on the received data.

The embodiments described above may be implemented in the form of a computer program that is executable through various elements on a computer, and the computer program may be recorded on a computer-readable recording medium. Examples of the computer-readable recording medium may include a magnetic medium such as hard disk, floppy disk, and magnetic tape, an optical recording medium such as CD-ROM and digital versatile disc (DVD), a magneto-optical medium such as floptical disk, and a hardware device particularly configured to store and execute program instructions, such as ROM, RAM, and flash memory.

The computer program may be those specially designed and configured for the disclosure or those known to and usable by those of ordinary skill in the field of computer software. Examples of the computer program may include not only machine language code generated by a compiler, but also high-level language code that is executable using an interpreter by a computer.

According to an embodiment, the methods according to various embodiments of the disclosure may be provided by being included in computer program products. The computer program products may be traded between a seller and a buyer as commodities. The computer program products may be distributed in the form of a machine-readable storage medium (e.g., CD-ROM), or may be distributed (e.g., downloaded or uploaded) online, either via an application store (e.g., Play Store™) or directly between two user devices. In the case of the online distribution, at least part of the computer program product may be stored at least temporarily on a machine-readable storage medium, such as a server of a manufacturer, a server of an application store, or a memory of a relay server, or may be temporarily generated.

Operations constituting methods according to the disclosure may be performed in any suitable order unless otherwise indicated herein or otherwise clearly contradicted by context. The disclosure is not necessarily limited by the order of operations. The use of any and all examples or exemplary terms (e.g., “such as”) provided herein is simply intended to describe the disclosure in detail, and the scope of the disclosure is not limited by the examples or exemplary terms unless otherwise claimed. In addition, it will be understood by those of ordinary skill in the art that various modifications, combinations and changes may be made according to design conditions and factors within the scope of the appended claims or equivalents thereof.

Therefore, it will be understood that the spirit of the disclosure should not be limited to the embodiments described above, and the claims and all equivalent modifications fall within the scope of the disclosure.

1. A lane centerline network determination method comprising:
obtaining a driving trajectory of a vehicle by using a global positioning system (GPS) mounted on the vehicle;
matching a road map with the driving trajectory;
generating road feature information considering the driving trajectory based on an image captured by an image capturing device mounted on the vehicle;
determining a position of a section node dividing a road on the road map into a plurality of sections based on the road feature information;
determining a lane centerline placement for each section by determining a lane centerline for the traveling lane of the vehicle among a plurality of lanes included in the section based on the driving trajectory, and estimating lane centerlines for remaining lanes;
determining a final longitudinal position of the section node based on reliability of the section node for each of driving trajectories through which the vehicle has passed a same road repeatedly;
determining a section network connection relationship between the section, a previous section, and a next section based on the lane centerline placement for each section;
determining a geometry of the lane centerline placement for each section based on reliability of a section link connecting the section nodes to each other; and
generating a lane centerline network based on the section network connection relationship and a lane centerline geometry within the section.

2. The lane centerline network determination method of claim 1, wherein
the section comprises section nodes and a section link connecting the section nodes to each other,
the method further comprises extracting, as a node list, section nodes generated from the driving trajectories estimated to have traveled the same road based on a certain criterion, and
road feature information corresponding to a section to which a certain section node belongs is matched with the certain section node.

3. The lane centerline network determination method of claim 2, further comprising tracking the section links and designating, as a node group, the section nodes in the node list that are located within a certain distance.

4. The lane centerline network determination method of claim 3, wherein the designating as the node group comprises designating, as a node group, the section nodes in the node list that are located within the certain distance and have same road feature information.

5. The lane centerline network determination method of claim 4, wherein the designating as the node group comprises, when there is no section node having the same road feature information within the certain distance, inserting a certain section node into a section link with a similar direction and a shortest distance and separating a lane centerline.

6. The lane centerline network determination method of claim 3, further comprising removing, from the section nodes in the node group, section nodes whose front/back position relationships are different based on an intersection section included in the road feature information.

7. The lane centerline network determination method of claim 3, further comprising, when a certain section node belongs to a plurality of node groups, designating, as a node group of the certain section node, a node group that has a high road feature information similarity to the certain section node and a closer distance to the certain section node.

8. The lane centerline network determination method of claim 3, further comprising determining a final longitudinal position of a representative section node, which merges the section nodes in the node group, by using node reliability of each of the plurality of section nodes included in the node group as a weight.

9. The lane centerline network determination method of claim 8, further comprising correcting final longitudinal positions of the section nodes in the node group so that a front/rear section length of the representative section node is greater than or equal to a certain length.

10. The lane centerline network determination method of claim 8, further comprising determining road feature information of the representative section node based on reliability of the section nodes included in the node group and road feature information matched with the section nodes.

11. The lane centerline network determination method of claim 8, further comprising:
designating, as a link group, links connected to the representative section node;
selecting, as an anchor section, a section corresponding to a link group with a highest reliability among a plurality of link groups based on a certain criterion; and
determining a section network connection relationship between a previous section and a next section based on the selected anchor section.

12. The lane centerline network determination method of claim 11, further comprising determining reliability of the link group by determining higher possibility of lane existence as the lane is closer to the traveling lane of the vehicle.

13. A lane centerline network determination apparatus comprising:
a memory in which at least one program is stored; and
a processor configured to perform operations by executing the at least one program,
wherein the processor is further configured to:
obtain a driving trajectory of a vehicle by using a global positioning system (GPS) mounted on the vehicle;
match a road map with the driving trajectory;
generate road feature information considering the driving trajectory based on an image captured by an image capturing device mounted on the vehicle;
determine a position of a section node dividing a road on the road map into a plurality of sections based on the road feature information;
determine a lane centerline placement for each section by determining a lane centerline for the traveling lane of the vehicle among a plurality of lanes included in the section based on the driving trajectory, and estimating lane centerlines for remaining lanes;
determine a final longitudinal position of the section node based on reliability of the section node for each of driving trajectories through which the vehicle has passed a same road repeatedly;
determine a section network connection relationship between the section, a previous section, and a next section based on the lane centerline placement for each section;
determine a geometry of the lane centerline placement for each section based on reliability of a section link connecting the section nodes to each other; and
generate a lane centerline network based on the section network connection relationship and a lane centerline geometry within the section.

14. A computer-readable recording medium having recorded thereon a program for causing a computer to perform the method of claim 1.
